(19) United States
(12) Patent Application Publication
(10) Pub. No.: US 2024/0122682 A1
(43) Pub. Date: Apr. 18, 2024

(54) A FASTENING SYSTEM, LOCKING ELEMENT, AND PROCESS FOR FORMING A SUPERSTRUCTURE, FOR A DENTAL IMPLANT SYSTEM

(71) Applicant: TOOTHIA AB, BUNKEFLOSTRAND (SE)

(72) Inventors: Bo EKSTRÖM, Bunkeflostrand (SE); Jens Christian LAURIDSEN, Ribe (DK)

(73) Assignee: TOOTHIA AB, BUNKEFLOSTRAND (SE)

(21) Appl. No.: 18/547,306

(22) PCT Filed: Feb. 22, 2022
(86) PCT No.: PCT/SE2022/050190

§ 371 Date: Aug. 21, 2023

(30) Foreign Application Priority Data
Feb. 24, 2021 (SE) 2150200-0

(51) Int. Cl. A61C 8/00

(52) U.S. Cl. CPC A61C 8/0054; A61C 8/0053; A61C 8/0063; A61C 8/0068

(57) ABSTRACT

A fastening system for a dental implant, the fastening system comprising: a locking element comprising a central throughgoing aperture, the aperture having a first distal portion, and a second proximal portion, the second proximal portion having a reduced inner diameter with respect to the first distal portion; a dental superstructure provided with a cavity for receiving the locking element, the cavity having a distal portion and a proximal portion separated by a shoulder, and a fastening element receivable within the cavity and the aperture, the fastening element being substantially restricted from distal displacement by the shoulder of the cavity.

### FIELD OF THE INVENTION

The present disclosure relates to a fastening system, a locking element and a process for forming a superstructure for a dental implant system. In particular, it relates to a fastening system with a locking element that is fixably received within a superstructure.

### BACKGROUND OF THE INVENTION

Dental implants are used to improve or restore the aesthetics, comfort, speech and general performance of a patient's dental condition. An implant generally comprises several components which are fixed together to provide a complete implant system.

The implant system generally comprises a dental implant which is fixed in the jawbone of a patient. The dental implant may be screwed or otherwise fixed into the bone of a patient. The dental implant is then connected to a superstructure, also known as a crown or bridge via a fastening system. The superstructure forms the external, tooth prosthetic element of the system.

The fastening system which connects the superstructure to the dental implant may comprise various components. Ideally, the fastening system allows the superstructure to be appropriately angled for its intended position in relation to the jawbone. The fastening system should also not add substantial additional height to the overall structure.

As would be clear, the fastening system generally comprises several small components, such small components are difficult to handle and there is a risk that the small components fall into the patient's trachea or oesophagus, resulting in accidental ingestion or aspiration, the patient therefore risks both serious complications due to internal damage or even suffocation. (Cossellu et al, Accidental aspiration of foreign bodies in dental practice: clinical management and prevention; Gerodontology, 2013) This is a risk during both installation, adjustment, and removal of the dental implant system. In an attempt to reduce the risk to the patient, dental thread/floss may be attached to the various components so that they may be received if they are dropped into the patient's throat during a procedure. (Ratnaditya et al, A simplified method of preventing implant hex drive from aspiration or accidental swallowing during stage two implant recovery; J Int Soc Prev Community Dent., 2014) This is clearly not ideal as the thread needs to be attached to the components and increases the complexity of the procedure.

Furthermore, each additional new component which is fixed to the jawbone of a patient requires extensive regulatory testing. There is therefore an advantage in the use of existing approved products for insertion to the jawbone, combined with improved components which are not inserted to the jawbone of a patient to locate the superstructure.

Improved fastening systems are required which enable secure connection to dental implants, enable adjustable positioning, and reduce the risks and thereby increase safety for patients during procedures.

### SUMMARY OF THE INVENTION

Accordingly, the present invention preferably seeks to mitigate, alleviate or eliminate one or more of the above-identified deficiencies in the art and disadvantages singly or in any combination and solves at least the above mentioned problems by providing a fastening system for a dental implant, the fastening system comprising: a locking element comprising a central throughgoing aperture, the aperture having a first distal portion, and a second proximal portion, the second proximal portion having a reduced inner diameter with respect to the first distal portion; a dental superstructure provided with a cavity for receiving the locking element, the cavity having a distal portion and a proximal portion separated by a shoulder, and a fastening element receivable within the cavity and the aperture, the fastening element being substantially restricted from distal displacement by the shoulder of the cavity.

A locking element for a fastening system is further provided.

A superstructure is also provided.

A method of providing a fastening system is also provided.

The fastening system provides an easier to implant and/or extract system. The fastening system enables has a reduced angle dependency than existing systems. Furthermore, the system enables the reduction in diameter of access holes improving patient comfort and implant appearance. Additionally, the fastening system enables the provision of a dental implant system without the risk of loosening of small components from the superstructure during a dental procedure. The fastening system further provides for the use of existing approved components for provision into the jawbone of a patient, thereby enabling an improved fastening system with reduced regulatory demands.

Further advantageous embodiments are disclosed in the appended and dependent patent claims.

### BRIEF DESCRIPTION OF THE DRAWINGS

These and other aspects, features and advantages of which the invention is capable will be apparent and elucidated from the following description of embodiments of the present invention, reference being made to the accompanying drawings, in which

FIG. 1 is a cross-sectional schematic view of a fastening system for a dental implant according to an aspect. The dental implant is shown fixed into a jawbone.

FIG. 2 is an exploded, partial cross-sectional view of a fastening system for a dental implant according to an aspect.

FIG. 3 is a cross-sectional schematic view of a fastening system for a dental implant according to an aspect.

FIG. 4 is a cross-sectional schematic view of a fastening system for a dental implant. The cavity provided in the superstructure has two non-axially-aligned portions.

FIGS. 5A & B are cross-sectional schematic views of a fastening system for a dental implant. The dental implant is provided with an additional fastening element connected to the dental implant in the jawbone (jawbone not shown). In FIG. 5A the superstructure is above the fastening element. In FIG. 5B the fastening system has been secured to the additional fastening element.

FIG. 6 is a cross sectional schematic view of a fastening system for a dental implant. The dental implant is provided with an additional fastening system. The locking element of the fastening system is shown with a proximal region matching the shape of the distal portion of the dental implant.

### DETAILED DESCRIPTION

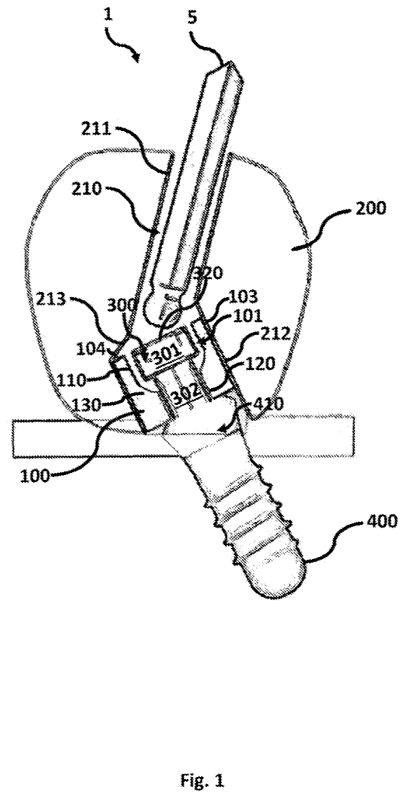

FIG. 1 shows a fastening system 1 for a dental implant, the fastening system 1 comprising a locking element 100 for being fixably received in a dental superstructure 200. The locking element 100 comprises an aperture 101. The aperture 101 has a first portion 110, and a second portion 120. The second portion 120 has a reduced diameter with respect to the first portion 110. The first 110 and second 120 portions separated by a shoulder portion 130.

The aperture 101 of the locking element 100 is provided through the locking element 100. The aperture 101 may be described as throughgoing, in that it extends through the locking element 100. The locking element 100 may be referred to as a locking ring 100. The locking element 100 is generally cylindrical in form. Due to the aperture 101 the locking element 100 may be described as a generally hollow cylinder. However, the locking element 100 need not be a cylinder, and may have an outer profile with angles, such as a typical nut, such that it cannot rotate with respect with the superstructure 200 after insertion into the superstructure 200. The first portion 110 of the aperture has a diameter which is greater than the second portion 120 of the aperture 110. A shoulder portion 130 is formed between the first and second portions 110, 120 of the aperture 101. The shoulder portion 130 is formed by the two different diameters of the first 110 and second 120 portions of the aperture 101. The shoulder portion 130 may be flat such that a stepwise change in diameter is provided between the first 110 and second 120 portions of the aperture 101. The shoulder portion 130 may be angled, curved, or otherwise formed such that a graduated change in diameter is achieved between the first 110 and second 120 portions of the aperture 101.

The locking element 100 is fixable within a dental superstructure 200. The locking element 100 may be fixed within the dental structure 200 via for example an adhesive or cement. The locking element 100 may be fixed via the provision of a collar, flange or otherwise protruding member 140 provided to the locking element 100. The protruding member 140 inhibits the movement of the locking element 100 relative the superstructure 200 in one direction, and enables movement of the locking member 100 relative the superstructure in the opposite direction. For example, the protruding member 140 may be a protruding ramp having an angled distal surface enabling insertion into the superstructure 200, and inhibiting removal of the locking member 100 from the superstructure 200 once inserted. The protruding member 140 may be provided around the outer circumference of the locking element 100, such that it forms a circumferential collar around the locking element 100. The protruding member 140 may also be provided around only a portion of the circumference. A plurality of protruding members 140 may be provided at points around the outer circumference of the locking element 100. A plurality of protruding members 140 may be provided at different points around the outer circumference of the locking element 100 and at different proximal and distal positions on the locking element 100, that is, the protruding elements need not form a single circumferential arrangement but may be arranged at different distances from the upper surface 104 on the outer surface 103 of the locking element 100. The protruding elements may be a plurality of key members 140 protruding from the outer surface 103 of the locking element 100. This is especially advantageous if the superstructure 200 is to be manufactured from a polymer as the connection between the locking element 100 and the superstructure 200 can be improved by the provision of several protruding members 140.

The outer surface 103 of the locking element 100 may be threaded such that it can be screwed into the aperture 210 of the superstructure 200. In such an arrangement, the aperture 210 is provided with an internal thread matching the external thread of the locking element 100.

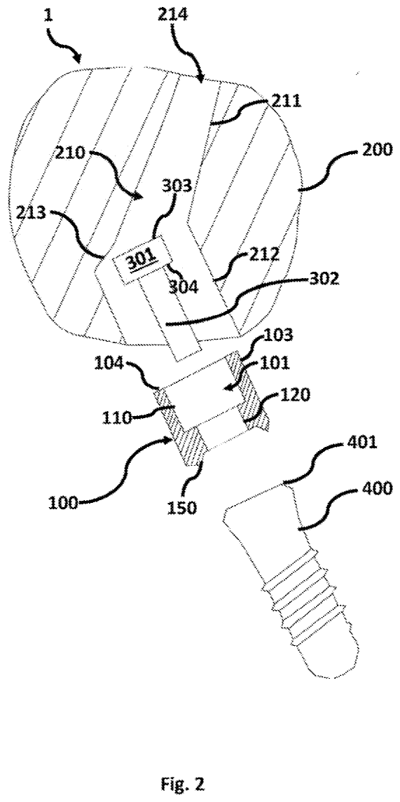

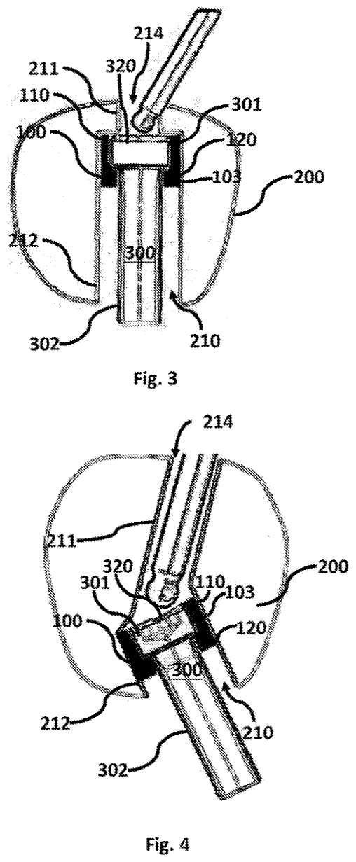

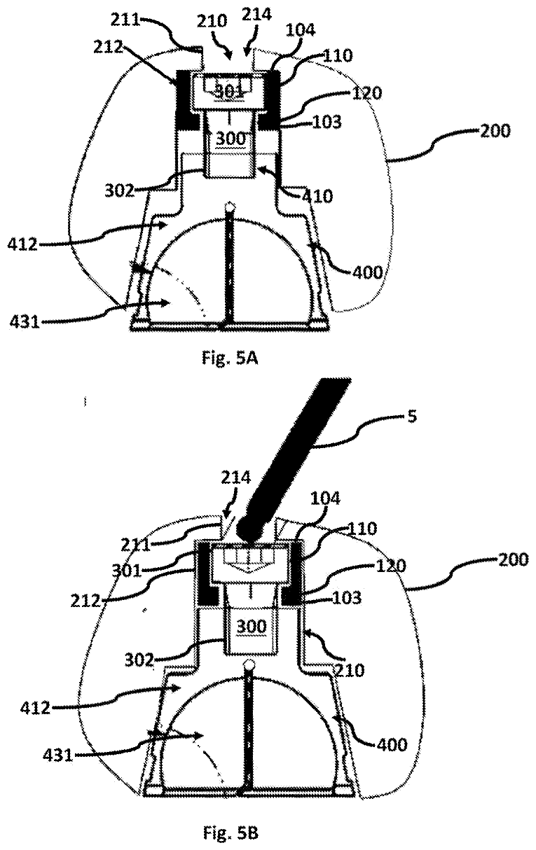

As shown in the figures, the superstructure 200 is provided with a cavity 210 for receiving the locking element 100. The locking element 100 is generally fully and completely received within the cavity 210 in the superstructure 200. The first, distal portion 110, of the aperture 101 is fully received within the cavity 210. The second, proximal portion 120, of aperture 101 is fully received within the cavity 210. The locking element 100 does not extend proximally from the cavity 210. The cavity 210 has a distal portion 211 and a proximal portion 212. The locking element 100 is received via the proximal portion 212 of the superstructure 200. The proximal portion 212 of the cavity 210 has a greater diameter than the diameter of the distal portion 211 of the cavity 210. The distal portion 211 of the cavity 210 has a diameter being less than the outer diameter of the locking element 100. In such an arrangement the locking element 100 cannot be inserted nor removed via the distal portion 211 of the cavity 210. The locking element 100 is thereby held within the cavity 210 via the geometry of the cavity 210, and any protruding member 140 and/or adhesive. The distal 211 and proximal 212 portions of the cavity 210 may be separated by a shoulder portion 213 which defines the geometry between the distal 211 and proximal 212 portions of the cavity 210. The distal 211 and proximal 212 portions may be axially co-aligned. That is, the distal portion 211 may have a central axis which is in line with the central axis of the proximal portion 212. Such an arrangement is shown in FIGS. 2-4. As shown in FIG. 1, the distal portion 211 need not be axially aligned with the proximal portion 212, each portion 211, 212 may have central axes which are non-co-axial. In the system 1 as shown in FIGS. 1 to 4, the axial alignment of the distal 211 and proximal 212 portions of the cavity 210 is generally determined by the angle at which the dental implant shall be fixed in the jawbone of the patient. The shoulder 213 may be at a range of angles with respect to the angle of the distal portion 211, and/or the proximal portion of the cavity 210. As shown in FIGS. 3, 5A & B, and 6, the shoulder 213 may be perpendicular to the wall of the distal portion 211 and/or the proximal portion 212 of the cavity 210.

The cavity 210 may be considered to be formed by a throughgoing aperture provided to the superstructure 200. That is, the cavity 210 is open at both ends. The cavity 210 is open at the distal portion 211 to receive the head of a driving device 4. The cavity 210 is open at the proximal portion 212 to receive the locking element 100.

The outer surface 103 of the locking element 100 generally abuts the cavity 210 of the superstructure 200. A distal portion 104 of the outer surface 103 may abut the cavity 210 of the superstructure 200. The distal portion 104 of the locking element 100 may abut the shoulder 213 of the cavity 210. As shown in FIG. 1, the locking element 100 may abut a portion of the shoulder 213, this is advantageous in superstructures 200 provided with non-axially aligned distal 211 and proximal 212 cavity 210 portions.

The fastening system 1 comprises a fastening element 300. The fastening element 300 fixes the locking element 100, and thereby the superstructure 200, to the dental implant 400. The fastening element 300 has a first distal end 301 and a second proximal end 302. The first distal end 301 of the fastening element 300 has an outer diameter which is greater than the inner diameter of the distal portion 211 of the cavity 210. Thereby the fastening element 100 is held by the locking element 100 within the superstructure 200, in particular it is held within the cavity 210 of the superstructure 200. The fastening element 300 is rotatable with respect to the locking element 100. As shown in FIGS. 1-5 the fastening element 300 may be a screw, having a screw head 320 at its distal portion 301 and a screw thread 310 at its proximal portion 302. The proximal portion 302 of the fastening element 300 is receivable within the dental implant 400. In the case where the fastening element 300 is a screw, the screw thread 310 is receivable within an inner thread provided to the dental implant.

The fastening element 300 is provided to the locking element 100 prior to insertion to the superstructure 200. During assembly, the fastening element 300 and the locking element 100 are inserted into the cavity 210 of the superstructure. After insertion to the cavity 210 both the fastening element 300 and the locking element 100 are substantially fixed within the cavity 210 of the superstructure.

The fastening element 300 is rotatable with respect to the locking element 100. This enables the use of a screw type fastening element 300 which is rotated by a driving member 4. As the locking element 100 is fixed within the superstructure 200, the fastening element 300 is also rotatable with respect to the superstructure 200. The term rotatable is used here to mean that the fastening element is rotatable around a central longitudinal axis, extending in line with the axis of extension of the fastening element.

As the locking element 100 and the fastening element 300 may be provided to and fixed within the superstructure 200 prior to insertion, there is no risk of the fastening element 300 loosening or being dropped into a patient's mouth. The locking element 100, the fastening element 300, and the superstructure 200 are provided as a single element which is easier for a dentist/dental-technician to handle.

As stated previously, the distal portion 301 of the fastening element 300 has an outer diameter which is greater than the inner diameter of a portion of the cavity 210. The fastening element 300 can therefore not be removed through the distal portion 211, nor the open distal end of the cavity 210.

As shown in FIGS. 1 to 6, only a portion of the cavity 210 need have an inner diameter which is less than the outer diameter of the distal end 301 of the fastening member 300. The entire distal portion 211 need not have an inner diameter less than outer diameter of the distal portion 301 of the fastening element 300 provided at least one region of the distal portion 211 has an inner diameter such that the fastening element may not be removed through the distal portion 211 of the cavity. In the arrangement shown in FIG. 1, the distal portion 211 of the cavity 210 obstructs the distal (upward as shown in the figures) movement of the fastening element 300 at the shoulder portion 213. The distal portion 211 of the cavity 210 is provided with an access hole 214. The access hole 214 to the distal portion 211 of the cavity 210 has a diameter less than the outer diameter of the distal end 301 of the fastening element 300. The access hole 214 has a diameter less than the outer diameter of the locking element 100. As the fastening element 300 and locking element 100 are insertable through the proximal portion 212 of the cavity 210, the access hole 214 need not be larger than the diameter of a driving member used to drive the fastening element 300. This is advantageous as smaller holes reduce the risk of infection, provide improved appearance and comfort to a patient.

The fastening element 300 is held distally in place via the distal portion 211 of the cavity 210 of the superstructure 200. The fastening element 300 is held proximally in place by the proximal portion 120 of the aperture 101 of the locking element 100. When the fastening element 300 is provided to the locking element 100 and the superstructure 200 it is substantially restricted from distal and proximal movement. The fastening element 300 is longitudinally i.e., in the direction of the length axis of the fastening element 300, restricted from movement with respect to the locking element 100 and the superstructure 200. The fastening element 300 is rotatable with respect to the locking element 100 and the superstructure 200.

The distal face 303 of the distal end 301 of the fastening element 300 may be provided at the shoulder portion 213 of the cavity 210 of the superstructure 200 such that the fastening element 300 is substantially longitudinally fixed. The proximal face 304 of the distal end 301 of the fastening element 300 abuts the proximal portion 120 of the aperture 101 of the locking element 100.

As can be seen in the figures, the distal end 301 of the fastening element 300 need not continuously abut the shoulder portion 213 of the cavity 210 provided that it is substantially restricted from distal displacement. For example, to enable rotation of the fastening element 300 with respect to the locking element 100 and superstructure 200, a tolerance may be provided between the shoulder 213 and the distal face 303 of the distal end 301 of the fastening element 300.

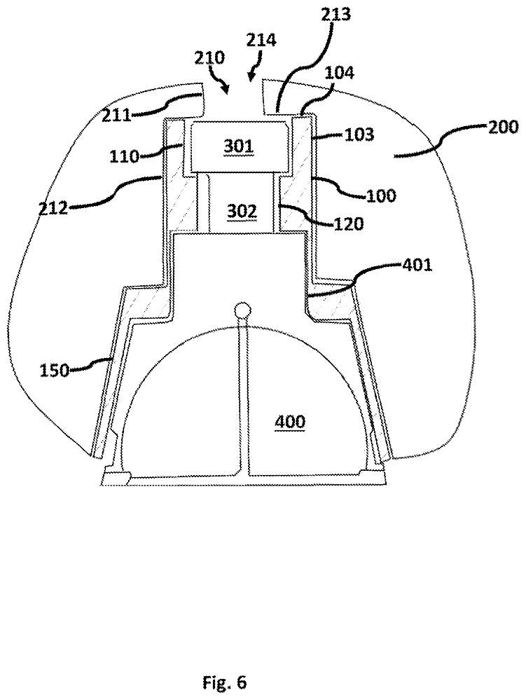

As the locking element 100 and fastening element 300 are provided fixed within the superstructure 200, the fastening element 300 does not move longitudinally with respect to the locking element 100, or the superstructure 200, during insertion or extraction from a patient. An advantage of this is that the fastening system 1, comprising the superstructure 200, the locking element 100, and the fastening element 300, are displaced and fixed as a whole on insertion or extraction from a patient. Further advantages of such an arrangement will be described below in relation to FIGS. 5 and 6.

The cavity 210 may be tapered at the distal portion 211 such that it is narrower than the distal portion 301 of the fastening element 300. The most distal opening at the distal portion 211 of the cavity 210 need only have a diameter sufficient for receiving the driving member 5 therethrough.

The length i.e., depth of the distal portion 211 of the cavity 210 may depend on the specific installation, and superstructure 200, design. As shown in FIG. 3, the distal portion 211 may have a relatively shorter length compared to the proximal portion 212, which provides the distal 301 end fastening element 300 closer to the distal end of the superstructure 200. Access to the fastening element 300 is easier in such an arrangement as the driving member 5 need not traverse a longer length of the distal portion 211 of the cavity 210. Furthermore, the angle range at which the driving member 5 is insertable into the distal portion 211 is increased. FIG. 4 shows an arrangement where the distal portion 211 of the cavity is longer than the proximal portion 212, which provides the locking element 100 closer the patient's jaw. In such an arrangement the driving member 5 traverses the distal portion at an angle defined by the axial angle of the distal portion 211 of the cavity 210.

The fastening element 300 is held between the locking element 100 and the superstructure 200 after insertion of the locking element 100 and the fastening member 300 into the superstructure.

The fastening element 300 cannot be removed via proximal (downwards as shown in the figures) extraction through the proximal portion 212 of the cavity 210 as the locking element 100 holds the fastening member 300 in place. In particular, the shoulder 130 of the locking element 100 abuts the distal portion 301 of the fastening element 300. The distal portion 301 of the fastening element 300 has a diameter greater than the inner diameter of the shoulder portion 130, and the second portion 120 of the locking element 100.

As described in the background section, a dental implant 400 is fixed into the jawbone of a patient. To attach the superstructure 200 to the dental implant 400 and thereby fix the superstructure 200 in place within the mouth, the fastening element 300 is fixed to the dental implant 400. The term dental implant 400 as used herein refers to either an element which is fixed to the jawbone of the patient, or an element which may be attached to the element fixed to the jawbone of the patient. By way of clarification, one may examine and compare FIG. 1 and FIG. 5. In the arrangement shown in FIG. 1, the dental implant is a threaded member explicitly shown to be fixed into the jawbone of a patient. The dental implant 400 has an internal thread 401 for receiving the fixing element 300. FIG. 5 relates to a fastening system described in WO 2015/152815 A1 (Simply Dental AB). In FIG. 5 the element fixed into the jawbone of the patient is not shown, however an additional structure which is substantially fixed to the element fixed within the jawbone is shown and is considered in this case to form the dental implant 400. Additional information on how this element is fixed to the jawbone may be found in WO 2015/152815 A1 (see FIGS. 3-7). The dental implant 400 is substantially fixed to the jawbone of the patient. The dental implant 400 as is meant in the present disclosure may therefore be a dental implant fixed to the patient's jaw, or as shown in FIG. 5, the dental implant 400 may be a fastening system substantially fixed to a dental implant.

As shown in FIGS. 5A, 5B and 6, the fastening element 300 may be fixed to the body 412 of the fastening system described in WO 2015/152815. The body 412 engages with the ball 431 portion of the fastening system of WO 2015/152815 such that the ball portion 431 is locked within the body 412. When the present fastening system 1 is combined with that described in WO 2015/152815, the fastening element 300 fixes the superstructure 200, and the locking element 100 with respect to the body 412. The fastening element 300 may fix the body 412 to the ball portion 431 such that after insertion of the fastening element 300 the body 412 is fixed to the ball portion 431. The insertion of the fastening element 300 expands the upper part of the body 412, which forces the lower part of the body 412 around the ball portion 431, such that it is fixed.

An advantage of the combination described above is that the present fastening system 1 enables insertion and/or extraction of the superstructure 200, locking element 100, fastening element 300 without substantial distal displacement of the fastening element 300. Due to the ball 431 the superstructure 200 may be rotated or angled such that access at a wide range of angles is possible. This is especially advantageous when several dental implants have been fixed into a patient's jaw and where the angle of extraction of a traditional fastening screw, or superstructure would be interfered with by the adjacent implants. As shown in FIG. 5 the superstructure 200 may be adjusted relative to the patient's jaw after release of the fastening element 300 from the body 412.

In the system 1 of FIGS. 5 and 6, the distal portion 211 and the proximal portion 212 of the cavity 210 are generally in axial alignment, as the ball 431 enables the adjustment of the superstructure 200, including the cavity 210, with respect to the angle at which the implant is fixed into the bone of the patient. As shown in FIGS. 5 and 6, in a system 1 comprising the ball 431, the distal portion 211 of the cavity 210 may be such that the distal end 301 of the fastening element 300 is provided in the vicinity of the distal surface of the superstructure 200, enabling improved access by the driving member 5.

The dental implant 400 comprises a portion 410 for receiving and fixing the proximal portion 302 of the fixing element 300. The portion 410 for receiving the proximal portion 302 of the fixing element 300 is generally an internally threaded cavity 410 such that the fixing element may be screwed into the dental implant 400. As the fixing element 300 is fixed to the dental implant 400 via for example, a screw thread, the fixing element 300, the superstructure 200 and the locking member 100 are each fixed in place at the jawbone of the patient.

As described, the distal portion 301 of the fixing element 300 generally comprises a screw head 320. The screw head receives a driving member 5 which is inserted through the distal portion 211 of the cavity 210 of the superstructure 200. Specifically, the driving member 5 is inserted through the access hole 214. The screw member is for rotating the fixing element 300, and thereby fixing the fixing element 300 to the dental implant 400.

The socket 321 for the driving member, that is, the part which receives the driving member 5 may be a traditional hexagonal/hex socket, however other socket types and their respective driving members as used within the dental field would be suitable. Generally, the driving member 5 has a ball hex head for angled driving of the fastening element 300.

The proximal base 150 of the locking element 100 may be shaped such that it abuts and substantially matches the distal portion 401 of the dental implant 400. That is, the locking element 100 may have a base which is shaped to match the shape of the distal portion 401 of the dental implant 400. Through such an arrangement gaps within the fixing system 1 are minimised which reduces the risk of loosening and in particular the potential for infection at the implant site. Such a shaped base 150 of the locking element 100 is shown in FIG. 2 where the base 150 of the locking element 100, is shown to match the external surface of the distal portion 401 of the dental implant 400. The base of the locking element 100 may receive and fully abut the surface of the distal portion 401 of the dental implant 400.

Another shaped base 150 of the locking element 100 is shown in FIG. 6, where the locking element comprises additional projections proximal the dental implant 400 with respect to the second proximal portion 120 of the locking element 100. The shaped base 150 of the locking element 100 is formed around and substantially abuts a fastening element part of the dental implant 400. This provides for a locking element 100 which has better mating to the surface of the dental implant 400 and therefore reduces the risk of infections at the site, and may enable the provision of superstructures 200 in a wider range of materials as the locking element 100 can spread the forces applied through the superstructure 200 more thoroughly to the dental implant 400.

A procedure for preparing a superstructure will now be described.

The superstructure 200 may be provided initially. Generally, superstructures 200 are produced according to a patient's requirements matching the appearance of existing teeth and formed according to the patient's needs. The method includes providing a cavity 210 to the superstructure 200. As described above, the cavity 210 comprises a distal portion 211 and a proximal portion 212, wherein the distal portion 211 has a reduced diameter with respect to the proximal portion 212. A fastening element 300 is provided to the aperture 101 of the locking element 100. The locking element 100 is inserted to the superstructure 200 via the proximal portion 212 of the cavity. Thereby the locking element 100 and the fastening element 300 are fixed within the superstructure 200. As described previously, the locking element 100 may be fixed within the superstructure via an adhesive such as a dental cement, or may be fixed via the outer geometry of the locking element 100 with respect to the cavity 210 of the superstructure 200.

The terms proximal and distal as used throughout the disclosure relate to the relative location of elements with respect to the jawbone of the patient. As would be understood a dental implant 400 may be provided to the upper jaw, maxilla, or the lower jaw, mandible. An element or feature distal another element or feature is further from the bone. An element or feature proximal another element or feature is closer to the bone.

Although, the present invention has been described above with reference to specific embodiments, it is not intended to be limited to the specific form set forth herein. Rather, the invention is limited only by the accompanying claims.

In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc. do not preclude a plurality. Reference signs in the claims are provided merely as a clarifying example and shall not be construed as limiting the scope of the claims in any way.

1-13. (canceled)

14. A fastening system for a dental implant, the fastening system comprising:
a locking element comprising a central throughgoing aperture, the aperture having a first distal portion, and a second proximal portion, the second proximal portion having a reduced inner diameter with respect to the first distal portion;
a dental superstructure provided with a cavity for receiving the locking element, the cavity having a distal portion and a proximal portion separated by a shoulder; and,
a fastening element receivable within the cavity and the aperture, the fastening element being substantially restricted from distal displacement by the shoulder of the cavity.

15. The fastening system according to claim 14, wherein the fastening element is receivable within and rotatable with respect to the aperture of the locking element, a distal end of the fastening element having an outer diameter greater than the inner diameter of the second proximal portion of the locking element.

16. The fastening system according to claim 14, wherein the fastening element has a proximal end being securable to a dental implant.

17. The fastening system according to claim 14, wherein the cavity has a distal portion having at least a portion of thereof which has a diameter less than an outer diameter of the locking element.

18. The fastening system according to claim 14, wherein an access hole to the distal portion of the cavity has a diameter less than the outer diameter of the distal portion of the fastening element.

19. The fastening system according to claim 14, wherein a proximal portion of the cavity is for receiving the locking element therethrough.

20. The fastening system according to claim 19, wherein the locking element is fixed within the superstructure such that it cannot be extracted in a proximal direction after insertion.

21. The fastening system according to claim 14, wherein the locking element is fully and completely received within the cavity such that it does not extend proximally from the cavity.

22. The fastening system according to claim 14, wherein the fastening system comprises a dental implant comprising a seat portion for receiving a ball portion, and wherein the seat portion is fixable to the ball portion via insertion of the fastening element.

23. A method for producing a superstructure of a dental implant, the method comprising:
providing a cavity to the superstructure, the cavity comprising a distal portion and a proximal portion separated by a shoulder portion, wherein the distal portion has a reduced diameter with respect to the proximal portion,
providing a locking element, wherein the locking element comprises a throughgoing aperture, the aperture comprising a first distal portion and a second proximal portion, the inner diameter of the first distal portion being less than the inner diameter of the second proximal portion,
providing a fastening element to the aperture of a locking element,
inserting the locking element via the proximal portion of the cavity of the superstructure, and thereby fixing the locking element and the fastening element within the superstructure such that the fastening element is substantially restricted from distal displacement by the shoulder of the cavity.

24. The method according to claim 23, wherein the locking element is fully received within the cavity and does not extend proximally from the cavity.

25. A superstructure for a dental implant, the superstructure comprising a cavity having a proximal portion, the proximal portion being adapted to receive a locking element, the locking element comprising a throughgoing aperture, the aperture comprising a first distal portion and a second proximal portion, the inner diameter of the first distal portion being less than the inner diameter of the second proximal portion, wherein the cavity of the superstructure has a distal portion, the distal portion having an inner diameter less than the inner diameter of the proximal portion.

26. The superstructure according to claim 25, wherein the proximal portion of the cavity is adapted such that the locking element is fully received within the cavity and does not extend proximally from the cavity.
